(19) United States
(12) Patent Application Publication
(10) Pub. No.: US 2025/0222287 A1
(43) Pub. Date: Jul. 10, 2025

(54) CHEST HARNESS

(71) Applicant: FRANKIE ELDER-REEDY, PLEASANTON, KS (US)

(72) Inventor: FRANKIE ELDER-REEDY, PLEASANTON, KS (US)

(21) Appl. No.: 18/404,602

(22) Filed: Jan. 4, 2024

(51) Int. Cl. A62B 35/00

(52) U.S. Cl. CPC A62B 35/0025

(57) ABSTRACT

The present invention provides a improved chest harness configured for providing a unifying chest support during use, said improved chest harness providing a central junction, a pair of upper diagonal straps in communication with the central junction, a pair of lower diagonal straps in communication with the central junction and spaced opposite the upper diagonal straps, a pair of adjustable fasteners associated with at least one of the upper diagonal straps and the lower diagonal straps and a circumferential belt secured to one of the upper diagonal straps or the lower diagonal straps.

### FIELD OF THE INVENTION

The current invention is related to chest support for use during exercise and more specifically to a chest support harness to support the wearer's chest and to reduce discomfort during use.

### BACKGROUND OF THE INVENTION

Chest supports such as brassieres or running bras have been known for years and are generally composed of an elastic wrapping member which is designed to encircle the chest of the wearer to assist in support and providing an upward force upon the wearer's breasts during use. Most brassieres are fabricated from various components, such as a frame, straps, cups, underwires, side wings, a back band, a center bridge, and clasps, which are sewn together. Generally, these brassieres have insufficient support during high-impact physical activities such as running, soccer, jumping, dancing, horseback riding, basketball, mountain climbing or walking. Upward support provided by a typical brassiere may be insufficient to adequately support the breasts or limit movement during these strenuous activities. Also, some occupations are physically demanding such as law enforcement. Different sports and occupations require different ranges of motion and support thus there exists a need for a chest support which is adjustable to suite the support for wearers who exert themselves in strenuous exercise or activities.

In general, exercise can impact the biomechanics of the participant in a number of ways including, during repetitive vertical motion, the Cooper's ligaments which support the breast tissues can become strained which can lead to discomfort and pain. Movement when exercising can result in a temporary pain and discomfort upon breasts which over time can lead to a more permanent stretching of the Cooper's ligaments and strain upon the surrounding skin. In addition, excessive movement can cause chafing and irritation during movement of the breast tissue. Additionally, uncontrolled breast movement can cause discomfort and hinder athletic performance, impact confidence and decrease the overall enjoyment experienced during the exercise.

Current methods for addressing breast movement include encapsulation which generally provides a cup or semi-spherical shape to encapsulate the breasts in an effort to minimize bouncing and provide support. However, these encapsulation methods typically provide only limited support against downward movement and little to no support to limit upward movement. Additional methods include using a variety of compressive fabrics to provide additional stability control and reduce bounce. Additional supporting methods include use of internal slings to provide targeted support, mimicking the role of the Cooper's ligament, with elongated delicate fabric supports which extend downwardly.

In an effort to address some of the issues with traditional encapsulating bras, jogging bras or other supports have been designed to provide encircling and/or compressive support. While the encircling support devices provide additional support in comparison to a traditional brassiere, they are still inadequate. They do not adequately support the breasts of a wearer during vigorous exercise which requires additional support against the vertical and lateral movement during various activities. Often, users have different sized torsos and various sized breasts. Simply providing a wrap which provides compressive support through encircling the wearer fails to address the unique characteristic of each wearer and the lacks sufficient support for the variety of breasts and for the variety of forces exerted upon the breasts during various activities.

In addition, these compressive and encapsulating support members lack a substantial central junction from which the various straps and wraps extend. If a juncture is provided, it is typically a insignificant and simply extends between the encapsulating supports. Typical wraps or encircling supports extend across both breasts simultaneously. As a result, adjustments to the encircling supports extended across both breasts simultaneously. Providing a significant support junction which allows for individualized adjustments would be beneficial.

In addition, excessive pressure in the shoulder straps during sport and exercise, particularly for women with large breasts can cause discomfort, pressure and pain in certain circumstances. Generally, wider shoulder straps help with the discomfort. However, traditional encapsulating brassieres typically have delicate straps which are slight and minimal. It would therefore be helpful to provide an improved chest harness which reduces the forces exerted upon the shoulders with wider straps and which extend along the shoulders of women during exercise and sports.

For this reason, it would be beneficial to provide an adjustable chest harness which provides a central unifying junction for offsetting various forces based upon the desired support for the athletic activity. Thus, a chest harness having a central junction for angularly adjusting a plurality of straps extending angularly towards a circumferential belt which can be adjusted to provide the desired support for vigorous activities while allowing for individualized adjustments for a variety of physical breast and torso geometries would be beneficial.

Therefore, in view of the prior art, there exists a need for devices and methods a chest harness which provides for a central junction which adjusts as desired to at least in part address some of the aforementioned problems. The devices and methods of the present invention address these and other needs that will become apparent to those skilled in the art based on the following specification and the accompanying drawings.

### SUMMARY OF THE INVENTION

An improved chest harness comprising a central junction, a pair of upper diagonal straps in communication with said central junction, a pair of lower diagonal straps in communication with said central junction and spaced opposite said upper diagonal straps, a pair of adjustable fasteners associated with at least one of said pair of upper diagonal straps and said pair of lower diagonal straps, a circumferential belt connectably secured to at least one of said pair of upper diagonal straps and said pair of lower diagonal straps; and a releasable fastener associated with said circumferential belt.

### BRIEF DESCRIPTION OF THE DRAWINGS

FIG. 1 is an environmental view of the improved chest harness in accordance with an embodiment of the present invention.

FIG. 2 is right-side perspective of the improved chest harness in accordance with the embodiment depicted in FIG. 1.

FIG. 3 is front plan view of the improved chest harness in accordance with the embodiment depicted in FIG. 1.

FIG. 4 is rear plan view of the improved chest harness in accordance with the embodiment depicted in FIG. 1.

### DETAILED DESCRIPTION

Certain terminology will be used in the following description for convenience in reference only and will not be limiting. For example, top, bottom, front, back, right and left refer to the illustrated embodiment as oriented in the view being referred to. The words “upwardly” and “downwardly” refer to directions up or down and away from, respectively, the geometric center of the embodiment being described and designated parts thereof. Such terminology will include the words specifically mentioned, derivatives thereof and words of similar meaning.

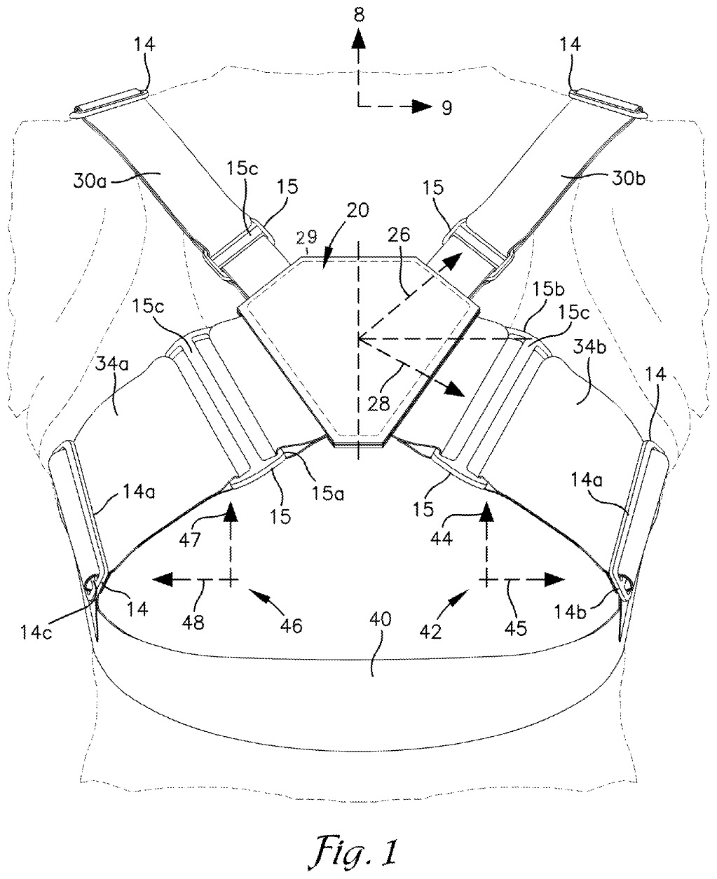

Referring to FIG. 1, the improved chest harness is generally referred to by reference numeral 10 and in one embodiment is illustrated with a two pairs of diagonal straps 30, 34 each connectably extending from a central junction 20 with at least one fixed connector 15, at least one adjustable fastener 14 and a circumscribing belt 40 which is configured for releasable closure with a plurality of column fasteners 16 which in the depicted illustration of FIG. 4 are hook and eye style connectors but can be any form of releasable connector which is understood. In the depicted embodiment, the improved chest harness is configured to be worn over clothing and without encapsulating supports such as breast cups, although other embodiments may include cups or a combination of cupped and cupless supports.

Generally, the diagonal straps 30 illustrated in FIG. 1 include a pair of upper diagonal straps 30a, 30b and a pair of lower diagonal straps 34a, 34b and are configured to extend from the central junction in opposing directions. By way of example, the lower left diagonal strap 34a extends opposite the upper right diagonal strap 30b and the lower right diagonal strap 34b extends opposite the upper left diagonal strap 30a.

Additionally, the diagonally extending straps 30, 34 can be selectively varied in magnitude and orientation based on the use of the adjustable fastener 14. Changing the position of the adjustable fastener 14 will tighten or loosen the desired strap 30, 34 and change its orientation. Each of the adjustable fasteners 14 is configured for independent adjustment to compensate for various physical dimensions or breast sizes and to centralize the exerted forces towards the central junction 20. In this way, the upper and lower diagonal straps 30, 34 help offset the forces exerted by the opposing straps.

The central junction 20 is depicted as a diamond shaped structure with a supra region 23a and an infra region 23b with a number of sides or linear-edges 25 positioned along the central junction 20 circumference.

As depicted in FIG. 1, the upper pair of diagonal straps 30a, 30b generally extend outwardly and upwardly from a supra region 23a, the lower pair of diagonal straps 34a, 34b extend outwardly and downwardly from the infra region 23b. Generally, a central vertical axis 8 extends upwardly along the central junction. An orthogonally oriented lateral axis 9 extends laterally from the central junction 20, parallel to the circumscribing belt 40.

In an exemplary illustration, each breast (not shown, associated with a wearer may be depicted by a pair of inferior axes 42, 46, each including a vertical component 44, 47 and a lateral component 45,48 extending outwardly.

The central vertical axis 8 is generally in central alignment with the torso depicted in the environmental view of FIG. 1. As further illustrated in FIG. 1, the upper vertically angular axis 26 extends angularly from the central junction 20 along one of the upper pair of diagonal straps 30. As further illustrated in FIG. 1, the downward vertically angular axis 28 extends angularly from the central junction 20 along one of the lower pair of diagonal straps 34. The upper and downward vertically angular axis 26, 28 are offset from the central vertical axis 8 between 20 and 70 deg from the lateral axis 9 illustrated in FIG. 1. As further illustrated in FIG. 1, the lateral axis 9 is generally depicted as being orthogonal to the central vertical axis 8. The vertically angular axis 26 represents the upper diagonal force vector which is exerted upon the central junction 20. The downward vertically angular axis 28 represents the lower diagonal force vector which is exerted upon the central junction 20. Generally, a similar lower diagonal force vector is exerted upon the central junction by the opposite lower diagonal strap 34.

Generally, each vertical force vector 44, 47 varies in magnitude independently depending on the exerted forces on the respective body mass and the physical activity. Likewise, each lateral force vector 45, 48 will vary depending on the exerted forces from the respective body mass and the physical activity.

For example, during sports and exercise a user may experience a variety of internal and external forces. As the wearer's body moves in one direction, the breasts (associated with the inferior axes 42, 46) may move in a different direction. During movement, each breast may exhibit a rotational inertia or velocity vector which is independent from each other and from the torso of the wearer. Through independent manipulation of the adjustable fasteners, the independent forces may be centralized along the central junction 20 where they may be cancelled by any opposing force and communicated to the circumscribing belt 40.

In an embodiment where the first inferior axis 42 corresponds to the right breast and the second inferior axis 46 corresponds to the left breast, the force vectors associated with the first inferior axis 42 will generally be presented to the central junction 20 by the upper right diagonal strap 30b and the lower right diagonal strap 34b. The force vectors associated with the second inferior axis 46 will generally be presented to the central junction 20 by the upper left diagonal strap 30a and the lower left diagonal strap 34a. The overall force exerted upon the improved chest harness 10 will vary based on vertical and lateral force vectors components from each of the inferior axes 42, 46 and can be manually adjusted through the adjustment of the adjustable fasteners 14 and the shape of the central junction 20. For example, extending the central junction 20 outwardly may alter or reduce the force exerted at a specific location resulting in additional stress or strain at the central junction which may cause additional stress or strain to be felt at the opposing diagonal strap. Generally, the more centralized the force vectors the more likely they are to offset each other.

In the depicted embodiment of FIGS. 1-4, the diagonal straps 30, 34 connect to the central junction 20 with the use of the fixed connector which selectively extends from the edges 25 of the central junction 20 at opposing angles. Generally, the edges of the central junction 20 are linear and are directed towards the axes associated with each of the upper and lower diagonal straps 30, 34 along, for example, the upper vertically angular axis 26 or the lower vertically angular axis 28.

In one embodiment, the upper diagonal straps 30a, 30b may be configured to include a transition structure 32 between the proximate end 41 and the distal end 43. By providing a transition structure 32, the upper diagonal straps 30a, 30b can remain flat while they transition from the mainly diagonal orientation associated with the extension from the central junction 20 to the mainly vertical orientation for connection to the circumscribing belt 40.

The depicted embodiment of the central junction 20 is generally resilient and in one embodiment is fabricated from a flexible woven material but may also include other materials or a combination of materials such as plastic or leather which allows for absorption and exertion of forces associated with the diagonal straps 30. In an alternative embodiment, the central junction 20 may include a compartment or pocket 29 for the storage of various personal accessories such as a key, card, jewelry or phone (not shown).

Generally, the chest harness 10 combines the exerted forces and redistributes them along the upper and lower diagonal straps 30, 34 which ultimately are extended to the circumscribing belt 40. Generally, the upper forces are communicated to the circumscribing belt 40 with the pair of upper diagonal straps 30. Generally, the downward forces are communicated towards the circumscribing belt 40 via the pair of lower diagonal straps 36.

In the depicted embodiment, the central junction 20 is a resilient hexagonally-shaped structure. Generally, the sides 25 correspond to being in communication with the upper and lower straps 30, 34 or the corresponding leader loops 24 which are in communication with the upper and lower straps 30, 34 by way of example, through the fixed connector 15. In one embodiment the central junction 20 is approximately 4″ tall and approximately 4 ½″ wide with at least one of the sides 25 associated with the upper diagonal straps 30 being approximately 1 ½″ wide to correspond with the dimensions of the upper diagonal straps 30. Additionally, at least one side 25 is approximately 3 ½″ to correspond with the dimensions of at least one of the lower diagonal straps 34. However, the sides 25 may vary as desired based upon the dimensions of the central junction 20 which generally may vary from approximately 2 ½″ to 8″ in height and width.

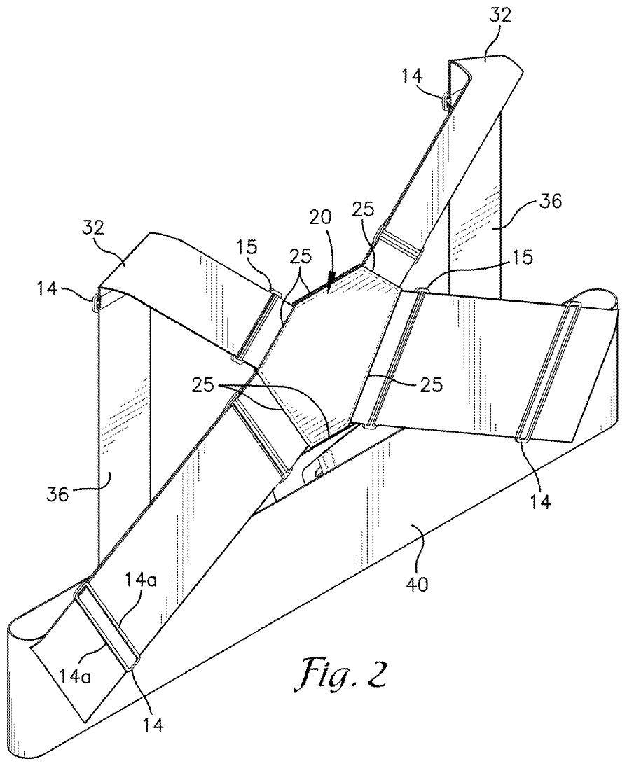

In one embodiment depicted in FIG. 2, the pair of upper diagonal straps 30 extend from the sides 25 associated with the supra region 23a. In the embodiment depicted in FIG. 2, the pair of lower diagonal straps 34 extend from the sides 25 which are associated with the infra region 23b. Each lower diagonal strap 34 extends from a proximate end 41 associated with the fixed connector 15 to a distal end 43 associated with the circumscribing belt 40. As further depicted in the embodiment depicted in FIG. 2, the circumscribing belt 40 extends circumferential, from the distal end 43 of each lower diagonal strap 34 to the connector 16.

The central junction 20 helps to centralize the inferior forces exerted by the diagonally extending straps 30, 34 which can be selectively varied in magnitude and orientation based on the use of the adjustable fastener 14, the connector 16 and the specific physical geometry of the wearer and the wearer's activities. Generally, the central junction 20 unifies the forces and exerts a counter stabilizing force directed towards the wearer's torso and breasts.

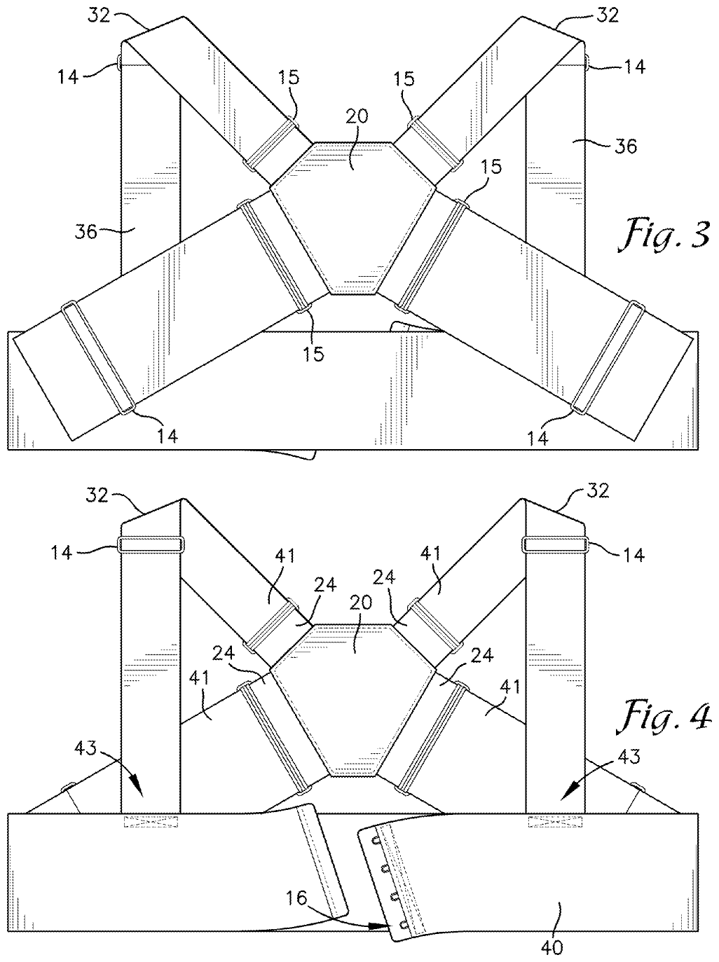

The upper diagonal straps 30a as depicted in FIGS. 3-4 extend angularly from the side 21a outwardly and upwardly from the central junction 20. Upon reaching the transitional region 32 the diagonal straps extend downward towards the circumscribing belt 40. As depicted in the embodiment of FIG. 1, a fixed connector 15 is positioned between the upper diagonal strap 30 and the central junction 20 prior to the transitional region 32. As depicted in FIGS. 1-4, an adjustable fastener 14 is associated with transitional region 32 on the upper diagonal strap 30 where the top side of the upper diagonal strap 30 is fastened to the inside of the circumscribing belt 40.

Generally, the transitional region 32 is associated with the area when the upper diagonal strap 30 transitions to a longitudinal strap 36 and is generally associated with a curvature which allows for a twist or change in direction without unnecessary bending or twisting. The longitudinal strap 36 includes a proximate end associated with the adjustable fastener 14 and a distal end secured to the circumscribing belt 40. As depicted in FIGS. 2-4, the longitudinal strap 36 is joined to the circumscribing belt 40 at a joint 38, which as depicted is a threaded mechanical joint.

In an alternative embodiment, the adjustable fastener 14 may be selectively positioned near the fixed connector 15 to improve the operation and comfort of the upper diagonal strap 30 along the transitional region 32.

As depicted in FIG. 1, each fixed connector 15 extends between a leader loop 24 and the upper and lower diagonal straps 30, 34. As depicted, the leader loop 24 extends between the sides 25 of the central junction 20 to one side of the fixed connector 15. The second side of the fixed connector 15 is configured for receipt of at least one end of the upper and lower diagonal straps 30, 34. An embodiment of four leader loops 24 depicted in FIG. 1, illustrates the loops 24 being secured to the central junction 20 along sides 25. The depicted embodiment of the leader loop 24 is illustrated as being comprised of a flexible material which extends outwardly from the central junction 20 and returns to the central junction 20 after wrapping around one end of the fixed connector 15. In general, the depicted embodiment of the leader loop 24 is generally fixed to the central junction 20 mechanically with, for example, thread but it may vary as understood. Leader loops 24 on opposing sides are generally configured to provide complementary offsetting forces at the central junction 20.

One embodiment of the fixed connectors 15 includes a generally buckle-like structure with a pair of spaced apart outer members 15a having a central member 15c extending therebetween, at least one outer member 15a being configured for connection with the leader loop 24 and the opposite outer member 15a being configured for receipt of the proximate end of the upper or lower diagonal straps 30, 34. The adjustable fastener 14 is generally depicted as a tri-glide slide with a central rail 14c extending between a pair of outer members 14a and joined by a pair of side rails 14b about which one end of the leader loop 24 and/or the diagonal straps 30, 34 are secured. Generally, the outer members 14a is configured for overlying threaded receipt of the upper or lower diagonal straps 30, 34 which frictionally resists undesired movement. The fixed connector 15 and adjustable fastener 14 while being depicted in a single embodiment, may generally utilize other known method of fastener or securing devices.

As depicted in FIG. 1, the embodiment of the diagonal straps 30, 34 have a narrower width than the circumscribing belt 40 and thus the adjustable fasteners 14 associated with the diagonal straps 30, 34 is narrower than the adjustable fasteners 14 associated with the circumscribing belt 40. In one embodiment, the upper diagonal straps 30a, 30b are 1″ wide, but may vary generally from ½″ to 2″ wide as desired. In one embodiment, the lower diagonal straps 34 are 3″ wide, but may vary generally from 1″ to 5″ wide as desired. In one embodiment, the circumferential belt 40 is 3″ wide but may vary generally from 1″ to 5″ wide as desired.

Each pair of leader loops 24 is configured according to the sides of the central junction 20 to limit the net forces exerted upon the central junction 20 in a static condition. Upon exertion, the diagonal straps 30, 34 and the circumscribing belt 40 may exhibit greater deflection. Generally, the increased longitudinal deflection of the diagonal straps 30 is focused to the central junction 20 and offset by the by longitudinal forces exerted by the circumscribing belt 40. Increased lateral deflection of one of the diagonal straps 30, 34 is focused to the central junction 20 and offset by the lateral deflection associated with the opposite diagonal strap 30, 34.

In addition, the adjustable fasteners 14 may be tuned by adjustment. Adjustment of the adjustable fasteners 14 away from or towards the central junction allow for tuning the compressive chest harness 10. In general, the compressive chest harness 10 is configured to maintain an inwardly oriented compressive force. To help maintain or adjust the amount of inwardly oriented compressive force, the compressive chest harness 10 can be tuned by adjusting the adjustable fasteners to decrease the lateral or longitudinal forces exerted upon the central junction 20.

The central junction 20 may include be fabricated from a variety of materials including but not limited to leather, vinyl, polymer/elastomeric strips or panels and may include a variety of shapes and sizes including, but not limited to, circular, oval, elliptical, triangular, square, or a similar shape. As depicted in FIGS. 1-8, the hexagonal shaped central junction 20 has sufficient dimensions to sufficiently securing the diagonal straps 30 while the forces exerted upon the central junction 20 can be adjusted using the adjustable fasteners 14.

Each of the diagonal straps 30, 34 is generally configured for directing the outwardly directed forces which may result from exertion as longitudinal and lateral forces which ultimately are dispersed along the circumscribing belt 40 and inwardly as a compressive force upon the central junction 20.

It should be understood that while certain forms of this invention have been illustrated and described, it is not limited thereto except insofar as such limitations are included in the following claims.

What is claimed and desired to be secured by Letters Patent:

1. An improved chest harness comprising:
a central junction
a pair of upper diagonal straps in communication with said central junction;
a pair of lower diagonal straps in communication with said central junction and spaced opposite said upper diagonal straps;
a pair of adjustable fasteners associated with at least one of said pair of upper diagonal straps and said pair of lower diagonal straps;
a circumferential belt connectably secured to at least one of said pair of upper diagonal straps and said pair of lower diagonal straps; and
a releasable fastener associated with said circumferential belt.

2. The improved chest harness of claim 1 wherein said chest harness is cupless.

3. The improved chest harness of claim 1 wherein said chest harness further comprises a pair of fixed connectors associated with at least one of said pair of upper diagonal straps and said pair of lower diagonal straps.

4. The improved chest harness of claim 1 wherein said central junction includes at least one pair of linear sides, each of said linear sides being positioned opposite each other and configured for receiving and communicating a reciprocal force to the opposite linear side.

5. An improved chest harness comprising:
a central junction
a pair of upper diagonal straps in communication with said central junction;
a pair of lower diagonal straps in communication with said central junction and spaced opposite said upper diagonal straps;
a upper vertically angular axis extending from said central junction through at least one of said upper diagonal straps; and
a lower vertically angular axis extending from said central junction through at least one of said lower diagonal straps whereby said upper vertically angular axis and said lower vertically angular axis at least partially offset each other at said central junction.
